(19) United States
(12) Patent Application Publication
(10) Pub. No.: US 2013/0219426 A1
(43) Pub. Date: Aug. 22, 2013

(54) Delivery of High Quality Videos to Mobile Devices and the Use of Virtual Currencies to Incentivize Watching of Videos

(71) Applicants: Jonathan Zweig, Los Angeles, CA (US); Paulo Brandao, Los Angeles, CA (US); Nikao Yang, Los Angeles, CA (US); Shlomo Yehekzel, Los Angeles, CA (US)

(72) Inventors: Jonathan Zweig, Los Angeles, CA (US); Paulo Brandao, Los Angeles, CA (US); Nikao Yang, Los Angeles, CA (US); Shlomo Yehekzel, Los Angeles, CA (US)

(73) Assignee: JIRBO, INC., Los Angeles, CA (US)

(21) Appl. No.: 13/410,855

(22) Filed: Mar. 2, 2012

Related U.S. Application Data
(60) Provisional application No. 61/600,042, filed on Feb. 17, 2012.

(51) Int. Cl. H04N 21/458

(52) U.S. Cl. 725/32

(57) ABSTRACT

The present invention is directed to the efficient delivery of high quality videos to mobile devices. These videos may be displayed in high definition and may be used to cause the display of advertisements on mobile devices. Because of the improved user experience, users may be more willing to view them than they would if advertisements were displayed in lower quality. Additionally, users can be incentivized to watch these videos by being awarded virtual currencies in exchange for having given their time to view the videos.

### CROSS-REFERENCE TO RELATED APPLICATION

This application claims the benefit of the filing date of U.S. Provisional Application Ser. No. 61/600,042, filed Feb. 17, 2012, the entire disclosure of which is incorporated by reference as if set forth fully herein.

### FIELD OF THE INVENTION

The present invention is directed to video and media advertising for wirelessly internet-connected devices.

### BACKGROUND OF THE INVENTION

As wirelessly internet-connected devices, also referred to as mobile devices, advance with full color displays and touch interfaces that allow for rich user-interaction and media viewing experiences, there is a growing demand for technologies that display high quality video over wireless network connections. Unfortunately, with the wide variability in the strength and speed of wireless networks, for both local WIFI and cellular networks, achieving videos of sufficiently consistent and high-quality via HTTP (hypertext transfer protocol) streaming can be challenging.

When developing systems for playback of videos, programmers and engineers must consider two primary types of activities: (i) the download and playback on the mobile device; and (ii) the formatting and transmission of data from the remote server. With respect to the former activity, typically video players attempt to “buffer” or pre-load a portion of the beginning of the media playback so that it can play off the local application cache or temporary internet file location. Unfortunately, many processes that use buffering technologies are unsatisfactory to users because they lead to interruptions in the playback of the videos.

With respect to the latter activity, there exist solutions to encode video content into multiple versions of differing quality, and subsequently file sizes in kilobytes, on the remote server. In these circumstances, requests may be made for the proper-sized streaming file that corresponds to the available connection type or quality. This solution is intended to allow for the streaming video to attempt to play without interruption or choppy-lag in a streaming video player, but in reality, for many applications it only reduces the effect somewhat.

The combination of the short-comings of presently known technologies can lead to the situation in which a user is exposed to different videos of differing qualities, thereby producing inconsistent user experiences with a video depending on the network type and strength. Moreover, there can be an inability to display video content when there is no viable internet connection at the moment in time in which the video is to be displayed. For example, if a device has detected a working internet connection, under previously known technologies, it may start to display the ad, but if the internet connection is lost, the ad experience may be broken and a viewer may witness skipping, pausing or other malfunctions during playback. Furthermore, nearly all solutions known to persons of ordinary skill in the art require a buffering period in order to connect to a data stream and to load enough information to begin playback.

Because of the limits on common technologies, publishers of advertising and other videos for viewing on mobile devices have faced resistance from the users of these devices who form the desired audience. This in turn has reduced the efficiency of targeting mobile device users with video advertisements.

Thus, downloading video content and displaying a video for a user on a wirelessly internet-connected mobile device, within all atmospheric and technological environments and scenarios, presents a set of technological challenges. Accordingly, there remains a need to develop better methods, systems and computer program products for downloading videos for playback on mobile devices.

### SUMMARY OF THE INVENTION

Various embodiments of the present invention are directed to the reduction if not elimination of skipping in the delivery of consistent high-quality video on wireless internet-connected devices regardless of internet connection quality. In some of these embodiments, these features can be obtained through one or more of the methods, systems and computer program products of the present invention, which manage a non-streaming solution that can fetch most if not all ad data and/or media assets before the ad is ready to be shown on the device. The software for fetching the data may be stored on the device itself.

The phrase “ad data” refers to elements that identify the ad within a network for the purpose of tracking views and other activities that pertain to that ad. Ad data may also include information that controls when and how the ad can be presented to a user. The phrase “media asset” refers to one or more if not all of a video file, a companion ad, other images, javascript, cascading style sheets (css), and audio assets that are required to display an ad as intended.

In some embodiments, a method of connecting to and communicating with an ad or media-server to receive ad data and media asset files for wireless download and display with minimal or no buffer time and maximal or 100% skip-proof and consistent high-quality playback experience is provided. Included is a set of complementary solutions to optimize one or more if not all of bandwidth usage, file transfer costs, network latency, and user experience, most notably speed and consistent high-quality regardless of connection and environment.

In some embodiments, a method is provided to store or to hold temporarily, data and tracked events such as media requests, plays, and other user activity securely on the device when there is no active or sufficient internet connection for the data transfer. The data is uploaded to one or more remote tracking servers that can complete the data transfer successfully. A method to report back to one or more remote servers to track and record data and media requests, plays, and other user activity is also provided. Thus, a device can be configured to communicate out to a remote server or servers in real-time when there is an active internet connection, or to retain the information until it can successfully communicate the data out to the remote tracking servers. In some embodiments, the software on device then manages the data stored therein. This data can be used to disseminate videos efficiently to a user of the mobile devices.

According to a first embodiment, the present invention provides a mobile device for the delivery of high quality videos comprising a computer program product stored in a non-transitory medium, wherein the computer program product comprises: (a) a manager module, wherein the manager module is configured to prepare a data file, wherein the data file comprises information corresponding to prior activity of the mobile device; (b) a downloader module, wherein the downloader module is configured to send a data request to a remote server, to receive in response to the data request an ad file that comprises ad data and media assets and to store the ad file locally on the device, wherein the data request comprises information corresponding to the data file; and (c) a playback module, wherein the playback module causes the mobile device to access the ad file stored on the mobile device and to display a video advertisement within a host application on the mobile device. The content of the ad file may be determined after a server analyzes the data request, thereby causing the advertisement to be selected based on prior activity of the user of the mobile device.

According to a second embodiment, the present invention provides a mobile device for the delivery of high quality video advertisements comprising a computer program product stored in a non-transitory medium, wherein the computer program product comprises: (a) a manager module, wherein the manager module is configured to interact with an application and to prepare a request for a data file, wherein the request comprises information corresponding to prior activity of the mobile device and information corresponding to a zone for a video advertisement within the application; (b) a downloader module, wherein the downloader module is configured to send the request to a remote server, to receive in response to the request an ad file that comprises ad data and media assets and if the ad file corresponds to a new ad, to store the ad file locally on the device, and if the ad file corresponds to an update of an ad already stored on the mobile device, to download only new or modified elements of the ad file, thereby updating an ad file stored on the device; and (c) a playback module, wherein the playback module causes the mobile device to access the ad file that corresponds to information received in response to the request and stored on the mobile device and to display a video advertisement that corresponds to the ad file that corresponds to information received in response to the request within a host application on the mobile device.

According to a third embodiment, the present invention provides a method for downloading high quality videos, the method comprising: (a) monitoring a history of activity of a mobile device, wherein the monitoring is automated and occurs locally on the mobile device; (b) transmitting a request to a server, wherein the request comprises information corresponding to the history; (c) receiving from the server an ad file comprising media assets in response to the request; (d) storing the ad file on the mobile device; and (e) playing an advertisement on the mobile device, wherein the advertisement comprises information contained within the ad file.

According to a fourth embodiment, the present invention provides a method for displaying a video advertisement on a mobile device, the method comprising: (a) activating an application on a mobile device, wherein the application comprises a video advertisement configuration request module; (b) transmitting to a remote server, a request for a video advertisement configuration; (c) receiving from the remote server the video advertisement configuration, wherein the video advertisement configuration comprises at least one parameter for a video advertisement; (d) retrieving media assets from local storage on the mobile device, wherein the media assets are selected based on information contained within the video advertisement configuration; and (e) displaying the video advertisement on the mobile device.

According to a fifth embodiment, the present invention provides a method for obtaining virtual currency comprising: (a) causing a mobile device to display a video within an application that offers virtual currency in exchange for viewing a video; (b) transmitting from the mobile device to a first server, information that corresponds to an identification of the mobile device and a notification that a video has been viewed; (c) receiving on the mobile device from the first server, an encoded URL; (d) accessing a second server from the mobile device through the encoded URL, wherein the second server is configured to decode the encoded URL and to determine whether to reward a user of the mobile device with virtual currency; and (e) receiving on the mobile device virtual currency. Preferably, the aforementioned steps are performed in the aforementioned order.

In some embodiments of the method of the previous paragraph, virtual currency is paid only upon the first completion of display of a particular video within a particular application on a particular mobile device. Thus, viewing of the same video on different devices by different users would entitle each user to an award of virtual currency, but two viewings by the same user in the same application on the same device would not entitle that user to two sets of virtual currency. In other embodiments, a user may receive additional virtual currency for reviewing the same video advertisement on the same device one or more of a second time, a third time, or a fourth time, etc. In some of these embodiments the total number of viewings may be capped at for example two to five viewings. By way of a non-limiting example the amount of additional currency for watching the same video may increase with each subsequent viewing, decrease with each subsequent viewing or remain the same. Furthermore, in some embodiments, the award of currency for additional viewings may be made only when a video advertisement has been updated or regardless of whether it has been updated.

### BRIEF DESCRIPTION OF THE FIGURES

FIG. 1 is a flow diagram of one embodiment of a software initialization and communication process of the present invention when there is a network connection, including the background downloading of a media asset up to being ready for the “play video” programmatic action.

FIG. 2 is a flow diagram of an embodiment of software making a request to check for video availability before attempting to display content.

FIG. 3 is a flow diagram of an embodiment of software making an actual video request to play/show media content (e.g., video, images, dynamic web content), while tracking and recording proper events throughout the user experience for server reporting transmission.

FIG. 4 is a flow diagram of one embodiment of software that is communicating with a remote server and an app server in order to authenticate a reward. Communication occurs via an application programming interface (API) callback, whereupon a reward accrues in a user's virtual currency balance.

FIG. 5 is a representation of a timeline flow diagram of the process of FIG. 4.

### DETAILED DESCRIPTION OF THE INVENTION

Reference will now be made in detail to embodiments, examples of which are illustrated in the accompanying figures. In the following detailed description, numerous specific details are set forth in order to provide a thorough understanding of the present invention. However, unless otherwise indicated, the details are intended to be examples and should not be deemed to limit the scope of the invention in any way.

Under various embodiments, a mobile device may run an application that calls for the display of an advertisement within the application. In these embodiments, the application initiates a computer program product or module that requests an ad server for an ad configuration. The phrase “ad configuration” refers to the information that defines which ad to play and when an ad has variable elements (e.g., language, size, extended vs. truncated version, etc.), which of those elements to use.

Through the ad configuration data, the ad server, which may be remote and configured to transmit information wirelessly, tells the device that it should play one or more specific ads. To accomplish playing the correct ads, the computer program product on the device may download the ad configuration data, which may include one or more new ads and or one or more updates to ads stored locally on the device, and may play the one or more ads in the configuration that the ad server has provided.

The next time that the application is launched, the computer program will create a new request for ad configuration data, and if an internet connection is available updates or new ads can be obtained. If no internet connection is available, the device will play one of the ads from what has previously been downloaded and stored on the device. A protocol on the device may direct the device which of the stored ads to play when no new ad configuration data is received. The above described technologies have at least three benefits that will readily be apparent to persons of ordinary skill in the art. First, even when there is no internet connection, a video advertisement will still be ready to be displayed within an application, thereby providing a user with a seamless experience. Second, when an internet connection is available, because only updates and not complete new sets of ad files are downloaded, less information needs to be transferred, and the traditional problems of streaming are diminished. Third, a request for ad configuration data can contain information pertaining to prior history of the device and permit an ad server to target specific users with specific ads.

In some embodiments, each time the device is connected to the internet or at periodic intervals, and regardless of whether a particular application has been launched, updates for ads stored on the device are requested and received. Accordingly, when the application is later launched, and a request for configuration is created, even if the internet is not available at that time, the ad data will typically have been updated recently.

Additionally, the systems and computer program products of the present invention may be configured such that there is an “as is ready” function, which enables a default ad to be played the first time that an application is launched.

Each of the features of these methodologies and the systems and computer program products that implement them are discussed more fully below.

Initialization and Remote Communication

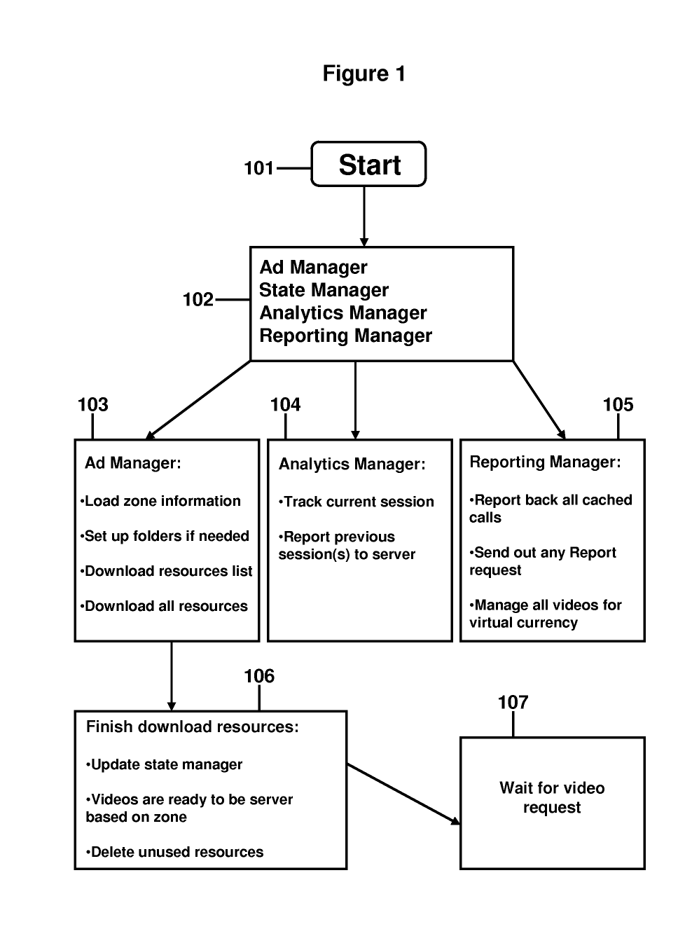

Contained in FIG. 1 is a flow chart of the initialization and required communication with a remote server for some embodiments of the present invention. The remote server may, for example, be an ad server or an asset server or a combination thereof.

An “ad server” is a computer server, typically a web server that can place advertisements on web sites. The terms “ad” and “advertisement” are used interchangeably, and refer to the presentation of information to a person for the purpose of inducing the person to act, e.g., to consider an issue, to purchase a product or service or to request more information about a product or service. An ad for display over the internet may have previously been presented to a publisher in the form of an “ad set,” which refers to a pre-bundled set of elements that make up an ad that is to be presented to a plurality or all recipients in the same way. Thus, the ad set may contain at a minimum, basic information about how and when an ad should be presented, as well as video, image and audio data that is required for the ad presentation.

The ad server stores advertisements that are used in online marketing campaigns and the ad server is configured to deliver them to website visitors or users of applications that are designed to display the ads. As persons of ordinary skill in the art are aware, the content provided by an ad server is typically updated regularly or irregularly so that over time the website or webpage on which or the application within which the ad is to be displayed contains new or updated advertisements. These new or updated advertisements may for example comprise, consist essentially of or consist of banners and/or text.

Two common types of ad servers are local ad servers and remote ad servers. Local ad servers are typically run by a single publisher and serve ads only to that publisher's domain. One benefit of using a local ad server is that it allows fine-grained creative formatting and content that is controlled by that publisher. Remote ad servers are configured to serve ads across domains that are owned by multiple publishers. Accordingly, they can deliver ads from one central source so that advertisers and publishers can track the distribution of their online advertisements and have one location for controlling the rotation and distribution of advertisements across the web. The systems, methods and computer program products of the present invention may be configured to work with local ad servers, remote ad servers or both.

As persons of ordinary skill in the art are aware, ad servers can make use of one or more methodologies for optimizing bid placements, targeting or other characteristics. Examples of these methodologies include, but are not limited to behavioral targeting and contextual targeting. Behavioral targeting refers to the use of a profile of prior behavior of a viewer in order to determine which ad to show during a given visit. Contextual targeting (which also may be referred to as semantic targeting) determines the optimum ad placement from information contained on the page where the ad is being served.

The phrase “asset server” refers to a computer server that possesses the means of storing and serving static content that populates a virtual world, which by way of non-limiting examples includes but is not limited to textures and three dimensional meshes to clothing definitions. Unless otherwise specified or apparent from context, the remote servers described herein may be ad servers, asset servers or combined ad/asset servers, which refers to servers that can function both as ad servers and asset servers and have one or more protocols that enable the execution of these features and operably couples these features. Features are operably coupled if they are configured to operate or to communicate in their intended manners for their intended purposes.

On devices such as a mobile device according to the present invention there may be a manager. The manager may be an ad manager, an asset manager or a manager that is both an ad manager and an asset manager, which may be referred to as a combined ad/asset manager and have one or more protocols that enable the execution of these features and operably couples these features.

The manager may provide an interface for an ad rendering component that is received from the server to interact with the device. For example, installed on each device may be an ad/asset manager, which may be stored as software, hardware or a combination thereof. On the device may also be a software application that facilitates the loading of the ad/asset manager and background downloading of media asset files and managing of files and resources. The software may be organized in the form of a manager module that when executed causes the manager to perform its intended function.

A mobile device of the present invention may for example be a cellular phone, a mobile device that has wireless telephone capabilities, a tablet or a smart phone (e.g., RIM® Blackberry™ products or Apple® iPhone™ products). These devices preferably have sufficient processing power, display capabilities, and connectivity (either wireless or wired), and the capability to display videos that have been transmitted according to the present invention. Each mobile device may comprise a central processing unit, a graphic user interface and the appropriate tools for establishing communication with, sending information to and receiving information from one or more servers over the internet or other network. The server, which may be a remote server, may for example be an ad server, an asset server or an ad/asset server. Furthermore, each device preferably has sufficient memory capabilities to store user activity data until a time that the data may be communicated to the server as described below.

The device may for example, store the information permanently on its persistent storage medium. Under various embodiments of the present invention, this information may remain within the persistent storage medium until the storage medium or the entire invention is uninstalled from a device. Alternatively, information may be stored for a predetermined amount of time and a device may at regular intervals delete the information or within a predetermined amount of time after data has been submitted to an ad server. When more than one application is configured to obtain and to present ads according to the various embodiments of the present invention, there may be separate storage locales for each application.

The downloader may acquire one or more if not all of video data, audio data and graphical images for the purpose of presenting an advertisement to a user at a later date. The time for display of the ad will depend on when the user launches an application that calls for ad data. The downloader may also acquire ad data that is required to identify an advertisement and to control its presentation to a user. Thus, the downloader may obtain and store locally everything that is required for the presentation of an advertisement, and if a user runs an application, the device may display an advertisement that is seamlessly integrated into a host application regardless of whether there is an internet connection the time of display of an advertisement.

The downloader may also contain an update feature (also referred to as a filter feature). Thus, if a downloader obtains data during a first internet connection at time T₁, and then becomes disengaged from the internet, it may reestablish access to the internet at T₂ and obtain updates to advertisement. Furthermore, the system may be configured such that only not previously downloaded features of the advertisement are downloaded at T₂ and with those new features, optionally are instructions to delete features that were downloaded at T₁ and that are being replaced or that should not be shown but for which there are no replacement elements. Thus, various embodiments may be designed such that after T₁ only the changes to the advertisements are downloaded. This will increase the efficiency of the system.

Device and User Data Collection

Preferably, each wirelessly internet-connected device has a wireless network adapter or cellular transmitter to communicate with wireless or cellular networks in order to send and to receive data. Software that is installed on a device may be used to extract the device and platform operation system information—such as device type, model, OS, version, Mac address, etc. —from the device's internal software/hardware. The software may also track user activity, including but not limited to one or more of frequency and/or time of use of the device, frequency and/or time of use of a particular application, duration of use of a device, duration of use of an application, and duration of display of a video advertisement within an application. This data may be used to track transmissions and assets trafficked between devices and remote ad/asset servers. Relevant registration data may also be collected and transmitted to the ad/asset server to better serve content to that device or user.

Requesting Media and Playback Functionality

Contained in FIG. 1 is a flow chart of the ad data and media asset file requests from the remote ad/asset server within a software application, as well as the setup and loading of the ad/asset manager and its resources. Once the ad/asset manager has been initialized 101 and setup by activating the ad manager, state manager, analytics manager and reporting manager functionalities, 102, the manager can then load data and request media assets from the remote asset server for assigned placements (i.e. ad zones, video slots).

The ad manager causes the device to load zone information, to set up folders if needed, to download resources lists and to download all resources 103. The zone information is the set of information that describes the playback for a particular ad placement, e.g., how often the advertisements should play. The phrase “resource list” refers to a set of all resources that are required for playback of an advertisement, and may include media assets and ad data. The folders allow the ad data and media assets to be structured for organizational purposes and to prevent any given advertisement's assets from conflicting with another advertisement's assets. Optionally, the software to run the manager contains threads as structural components. As persons of ordinary skill in the art are aware, a thread is the smallest unit of processing that can be scheduled by an operating system.

The analytics manager causes the device to track the current session and to report the previous session or sessions if there were any to the server 104. The tracked data may include one or more if not all of session length, history of viewing a video advertisement, device type, device operating system version and internet connection device. This information may for example be sent in JavaScript Object Notation (JSON) format or other similar format that may be used to serialize and to transmit structured data over a network connection between for example a server and application.

The information pertaining to the previous session may be presented as raw data or preprocessed prior to transmission in order to put it in a format that is more easily processed by a server. In one embodiment, on the device, data is collected and analyzed with respect to the previous session length, the device type and the operating system version, while on the server, analysis may be done to summarize the data and to store it for future analytics, e.g., reporting to the application owners, basic metrics about the total number of users, average session length, and total session time. The server may also maintain files that track a device's use over time in order to obtain macro information about a device's use.

The reporting manager causes the device to report back to the server all cached calls, to send out any report requests, and to manage all value exchanges for video ads for mobile applications (e.g., videos for virtual currency) communications 105. Information may be gathered by one or more servers and stored in one or more database servers.

After initialization of the ad manager, the state manager, the start analytics manager and the start reporting manager, the ad manager finishes downloading resources, including by updating the state manager, queues the videos to be served based on the zone, and deletes unused resources, 106.

After the conclusion of downloading the media and ad assets, the device waits for the video request 107 from for example an application. Thus, after the ad file or files have been downloaded, the videos may be ready to be displayed in the media player within an application. A play video function call displays the video using the device's video player. It will attempt to connect to the server intermittently or on-demand when needed to fetch updated data and media assets, if any. However, internet connection may not be necessary for an application to run an ad in a designated zone, because all necessary information will already be on the device prior to a request for ad presentation.

Background Asset Downloader & Asset File Manager

The background asset downloader retrieves files from the server based on a list received from the ad/asset manager configuration data request, and saves the list and files in the device's local document storage for local playback and display. The downloader may have one or more of several pieces of intelligent logic to manage bandwidth usage, including but not limited to one or more of the following: (1) understand connection-speed and bandwidth available, and allow the device and application to maintain the needed bandwidth for its internet activity; (2) only download minimal ads or assets initially and attempt to recognize the device's behavior to manage asset file transfers and trafficking; (3) allow ads/assets to expire if not displayed within required time frames; (4) resume downloading of asset files if the internet connection is interrupted or application is closed, exited, or powered off; (5) do not re-download assets that are identical and delete assets when they expire from the remote server; and (6) the pool size (amount of space that is allocated for ad and media assets) can be defined during the ad/asset manager initialization based on device data.

By way of a non-limiting example for feature (1) above, a device may obtain data through a 3G cellular connection. The connection may be made under conditions such that only a minimal number of ads (comprising, consisting essentially of or consisting of ad data and media assets) are obtained. If the device is, for example, on a WIFI connection, the device may be able to download a plurality of ads. The more ads that the device stores, the more varied the user experience may be, which is particularly advantageous during longer periods of an inability to access the internet.

In feature (2) above, the device may initially download a limited number of ads. For example the device may initially download 2 to 20 or 5 to 10 ads. Because the device tracks the viewing of the ads and sends this information back to the server, the server will gain a first impression based on a user's behavior, including running of an application and optionally duration of period without an internet connection, how many ads should be stored on a device and which ones are the most effective.

With respect to feature (3) above, the system may be configured such that ad data and media assets will be deleted from a device if they are not used within a certain amount of time, e.g., one day to two weeks. Alternatively or additionally, the system may be configured such that the assets are deleted if the application has changed its behavior in such a way that it is no longer showing ads within a zone. Furthermore, after an ad expires from a remote server, the system may delete the related ad and media assets. Expiration information may be contained within the data that has been downloaded and be absolute and call for expiration at a certain day and time. Thus, the ad may be configured to be deleted and the same time on different devices. Alternatively, system may be designed such that an advertisement's data is deleted after it has been viewed once or twice or three times or if it has sat on a device but has not been viewed after a finite period of time.

Still further, in some embodiments, information for expiration and deletion of data may come from a remote server at a time after the downloading of the ad data and media assets and call for immediate or scheduled expiration and deletion of ad data and media assets. Accordingly, in these embodiments, expiration information is not obtained at the time of downloading of ad data and media assets.

With respect to feature (4) above, if the device loses internet connectivity in such a way that any asset is only partially downloaded the system will resume downloading of the assets instead of re-downloading of the entire asset upon restoration of connection with the internet. This will avoid the unnecessary re-downloaded of duplicative data.

With respect to feature (5), the same asset e.g., graphical video or audio assets, may be used in more than one ad. In these cases, the system may be designed such that only one copy of the common assets is downloaded. This configuration further reduces the amount of data that needs to be stored on a device. If different ads share common elements and the ads are to expire at different times, then the system may be configured such that only the elements that are unique to the expiring ad are deleted at that ad's expiration time.

With respect to feature (6), the asset pool is a specific set of device memory that is allocated for assets. The size of the pool that is used may vary with the device configuration and server instructions.

Local Event-Data Storage and Remote Upload

Events tracked by the ad/asset manager are locally stored and transmitted appropriately to the remote server when there is an active internet connection. The types of events include but are not limited to views of an ad, engagements, skips and replays. When there is no active internet connection, all events are recorded to a local records file until there is an active connection to transmit the necessary data to the server. Once the remote server responds with a successful transmission response, the data may be discarded or deleted. These events can be mirrored for an additional party or parties or servers.

Offline Capabilities (No Internet Connection)

Once the ad/asset manager has been initialized and setup, and data and asset files have been downloaded and are “ready to display,” the device no longer requires an active internet to display the media content. It will use the ad/asset manager to manage the playable ads/assets based on parameters from the setup configuration data. As described above, all events are recorded locally for transmission when an internet connection has been established.

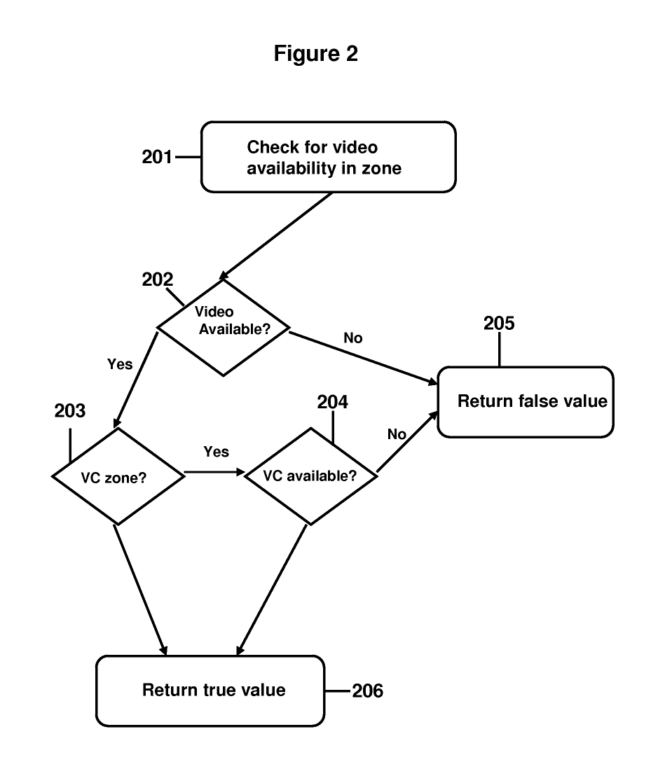

FIG. 2 provides an illustration of a process that makes a request to check for video availability before attempting to display content. According to this process, the system initiates a protocol for checking for video availability in a zone 201, by first asking if a video is available 202. A video is deemed available if all assets that are required for presentation on the mobile device exist locally on the mobile device. The zone identifier used in the ad request contains a configuration that allows for additional ad playback for the given request at the requested time. Furthermore, the ad configuration as provided by the ad server may allow for additional ad playbacks.

If the video is not available, then the system will return a false value 205. If the video is available, then a query is posed as to whether the video content (VC) zone is available 203. If the zone is available then the system will ask if the video content itself is available 204. If the video content is not available, then the system will return a false value 205. If the video content is available, the system will return a true value 206.

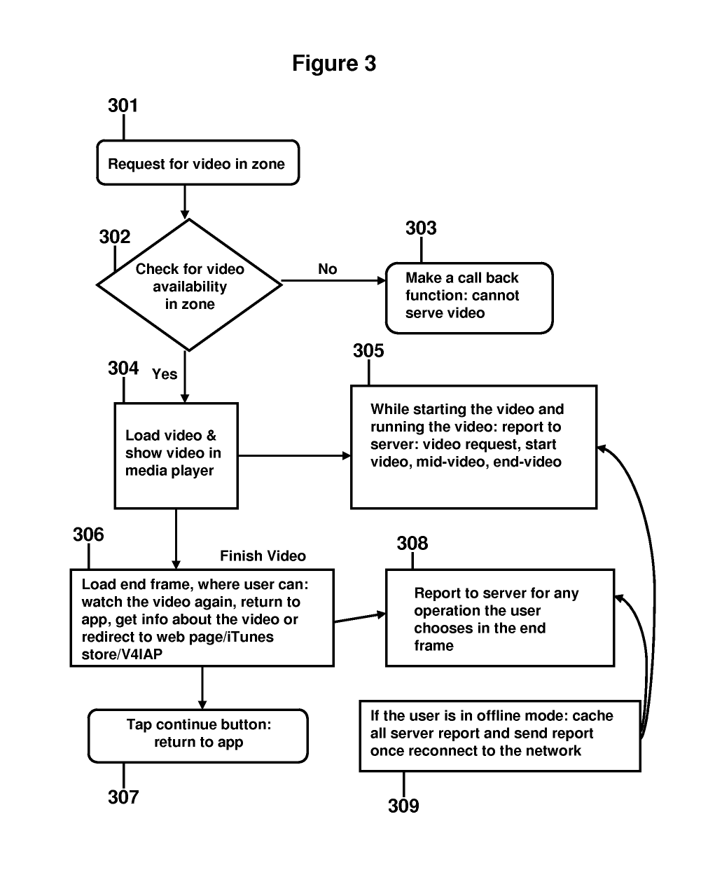

FIG. 3 is a flow diagram of one embodiment of a method for making a video request to play/show the media content. The request is made while tracking and recording proper events throughout the user experience for server reporting transmission.

The system initiates a protocol for a request for video in a zone 301. The first step is to check for video availability in a zone 302. Because zones can be configured differently, the application sends a request for showing of an ad based on a parameter of a zone. If no video is available, then the system makes a call back function determination that it cannot serve the video 303. If after checking for the video availability in the zone the conclusion is that the video is available, the video is loaded and shown in the video player 304. If multiple videos are stored locally that satisfy the requirements for playback within a zone, then the order of presentation may be determined by a protocol on the device, a protocol on the server, on a first in first out basis, or randomly.

While starting the video, while running the video or after the video has run, the mobile device reports to the server one or more if not all of a video request, start video information, mid-video information, and end video information, which may also be referred to as a video impression 305. The video request is a request from the application to a computer program product or system of the present to play a video. The “start video” step refers to when the computer program product or system of the present invention fulfills a request to show a video. The “mid-video” feature may be used to detect what duration of a video was watched when less than all of a video was watched. The “end-video” feature may be used to detect when a video is displayed in its entirety. If a video has been watched in its entirety, the mid-video data may be omitted from storage or transmission to a server. Tracking of this information also may be used in order to determine fill rate metrics for publisher and advertiser feedback, as well as ad server performance.

Upon finishing the video, the mobile device will load the end frame, wherein the user can watch the video again, return to the application that the user was running, obtain additional information about the video, or redirect the user to another webpage such as the iTunes store to the V4IAP 306. The system may be configured such that the operation that the user chooses in the end frame is reported to the server 308. If the device is in an offline mode, server reports may be cached and then reported after the device reestablishes a connection to the network 309.

The system may also be configured to permit the user to tap a continue button at any time or only upon completion of the video to permit him or her to return to an application that caused the video sequence play to be initiated 307.

The User Experience

In some embodiments, a primary motivation for the solution is to provide the best possible user experience in the form of quality and speed. Quality refers to the quality of the digital media asset, often time correlated to the asset file. Speed refers to how quickly it takes for the user to view the multimedia experience. Because the asset has been downloaded to a file stored on the device's local storage, once it is verified for distribution, it is played locally with no ad buffering or streaming at the size and location set in the setup configuration data. Any companion assets are also downloaded by the file assets background downloader for display.

The companion asset refers to a non-video entity that is displayed at the end of a video playback. It may prompt a user to act via a set of graphic representations of buttons. By way of a non-limiting example, the buttons may allow a user to repeat viewing of an ad, to select another ad to return to an application. The companion asset, like the video and all other media assets and ad data are preferably downloaded prior to an ad being presented.

Preferably the various embodiments of the present invention are configured such that all assets and videos are optimized to minimize the amount of bandwidth consumed during download. This may for example be accomplished by converting images to JPEG format and transcoding videos to optimal quality versus size.

In some embodiments, the systems may be configured to provide a user who watches the videos that have been displayed, virtual currency in exchange for having watched the videos. The videos may for example be presented within a virtual environment such that a user who has launched an application, e.g., is playing a game, can, before the game commences, during a pause in the game or at the same time as playing the game watch a video and receive virtual currency in exchange for having watched the game. The virtual currency is preferably in the denomination that is of value in virtual world of the game. The term “game” refers to an application in which there may be a goal to accomplish and in which an action or a response in a virtual world may be required.

On the back end, the methods, systems and computer program products of the present invention may be configured such that the playback feature described above is operably coupled to a virtual currency reward feature of a game either directly or through interfacing with another computer program product such that upon completion of the video virtual currency is deposited into a virtual account of the player. Notably, in these applications, the user is not required to download an additional application. He or she will have already downloaded the game, and his or her mobile device will already be configured to find and to display the appropriate ad.

Under some embodiments, the exchange between the ad manger and the virtual currency reward takes place as follows. First, a user watches an ad for virtual currency. Second the user's application then reports the impression (end of video) to the ad server. Third, upon verifying the validity of the impression, the server provides the computer program product or system on the mobile device with a callback URL.

Fourth, there is currency tracking and awards. Currency tracking and awarding may be accomplished on the device, or it may be accomplished by activity on the ad server and reported to the device. In the former embodiment, the mobile device (through for example the application in which the video was displayed), invokes the callback URL, which responds and permits the application itself to award currency and manage the currency account. In the latter embodiment, the ad server returns a success (vc_success) or failure (vc_failure) value for the related impression. The ad sever has a currency management module of its own and tracks any change in currency, reporting the change back to the device.

As described herein, the ability to use various embodiments of the present invention in connection with awards of virtual currency includes, but is not limited to the award of virtual currencies in denominations that are recognized by the game, virtual rewards, bonus points and/or bonus items. These virtual currencies may for example be used on mobile devices. There is no technological limitation as to the ability to apply the technologies of the present invention to devices that are not mobile, e.g., wired computers; however, the advantages of the present invention may be particularly noticeable when used in connection with mobile devices.

Within an application for which virtual currencies are applicable, the virtual currencies can be used or spent in the application as part of the core game play, to unlock additional functionalities, to access special items or to progress faster in the application or game. The award of virtual currencies in exchange for watching videos may be referred to as videos for virtual currency (V4VC). As persons of ordinary skill in the art will appreciate from a review of the present disclosure, V4VC technologies can allow for the issuance of virtual value entities for the action of watching to completion (or in part) a video within a game or an application.

Persons of ordinary skill in the art and users will also readily appreciate the value of the various embodiments of the present invention. In traditional uses of applications that are video games, the majority of users do not pay for items, levels or virtual currency with real world currency (which includes but is not limited to U.S. Dollars, Euros, Japanese Yen, etc., regardless of whether the currency is transferred in cash, by check, as part of a credit card transaction or part of a debit or gift card transaction). In fact, only a very small percentage of persons purchase virtual currency through micro-transactions that use real money. Thus, the overwhelming majority of customers proceed through games at their own pace and monetization (other than any cost to download the game itself if there is one) occurs through a publisher's interstitial and/or banner advertisements to the extent that those advertisements exist. However, to the extent that the advertisements are not opt-in (thereby removing the choice to view from the user), both users and publishers find the advertisements to be disruptive.

Through various embodiments of the present invention that may or may not take advantage of the technologies for downloading high quality videos described above, a value exchange may be set up by which developers and publishers can pay out virtual currencies to users. By offering enticements to view the videos, publishers will be able to have an increased number of persons voluntarily view their advertisements.

When presenting the videos, control variables can be used in order to manage the payout amount, the number of videos that may be viewed, the size of the video and the ability to present messages within a video. Furthermore, a publisher or developer (collectively “controller”) may be provided with controls as to where and when in a game to present a video. Thus, the publisher or developer may have the ability to determine the location of the video on a screen (e.g., if not full screen, then center, left, right, upper or lower), as well as when in the stage of game play, e.g., after a certain amount of absolute time, (e.g., between minutes 2 and 3) or at a certain level (e.g., after a player has reach a third level of difficulty or has acquired a certain number of points). The controller may alternatively or additionally define one or more parameters of the number of videos that may be watched in exchange for virtual currencies within a game, within a play level or within a certain amount of time.

The reward that a user obtains within an application or game may be binary such that the user must watch the entire video in order to obtain any reward. Alternatively, the system can be designed such that any reward is pro rated based on the amount of time that a user watches a video, with or without a bonus for completing his or her viewing of the video. As persons of ordinary skill in the art will recognize, a video is deemed to have been watched if it has been displayed on a device.

Administratively, the system in which virtual currencies are awarded may be through a remote server (a first server) that is configured to manage, to authenticate and to communicate directly or indirectly with another server (a second server) using an appropriate API. Communication between the user's device and the first server, and between the user's device and the second server, may be accomplished in real time so that upon completion of the viewing of the video, a user is made aware that he or she has received the reward. The user may be made aware through for example a text display that the reward has been delivered or through watching a display of his or her virtual bank account changing the amount of virtual currency within it or a combination thereof. In some applications, the user remains in the application while watching the video. Optionally, for applications in which the user has only a finite amount of time to play, this time may be stayed for the duration of the video. Thus, the game or application clock will not continue to run.

Under one embodiment, upon initialization of an advertisement or content delivery system, a remote server sends directly or indirectly to an app server, data sufficient to configure the reward values, limits, callback URLs (uniform resource locators) and message strings. This data, which may be referred to as configuration data controls one or more if not all of: (1) a reward amount and currency name; (2) a limit on the rewards that a user can earn daily or in total; (3) what remote callback URL can be used to reward users; and (4) the message strings for the optional pre and post message pop-ups.

During an application, a user may be shown a message that he or she will earn X virtual currency units for viewing and/or engaging in content. In some embodiments, if a user initiates playing of the video, upon completion of the video, the user will be rewarded with currency and shown a message that he or she has earned the currency. The currency account for a user may be changed to reflect the addition of this currency, and through a display on the device, the user may see that he or she has received the virtual currency.

The user may repeat the process by watching different videos, thereby receiving additional currency until they have reached a limit for the application imposed on the system. If a user has reached his or her limit and the user tries to access a video, a message may be displayed that notifies the user that the limit has been reached. In some embodiments, the publisher may seek to set a maximum limit on the amount of virtual currency that a user may be rewarded that is a fraction (e.g., ½ or ¼ or 1/10 or 1/100) of the amount of virtual currency that a user may purchase with real currency or is a fraction of the average of the amount of virtual currency that a user purchases with real currency.

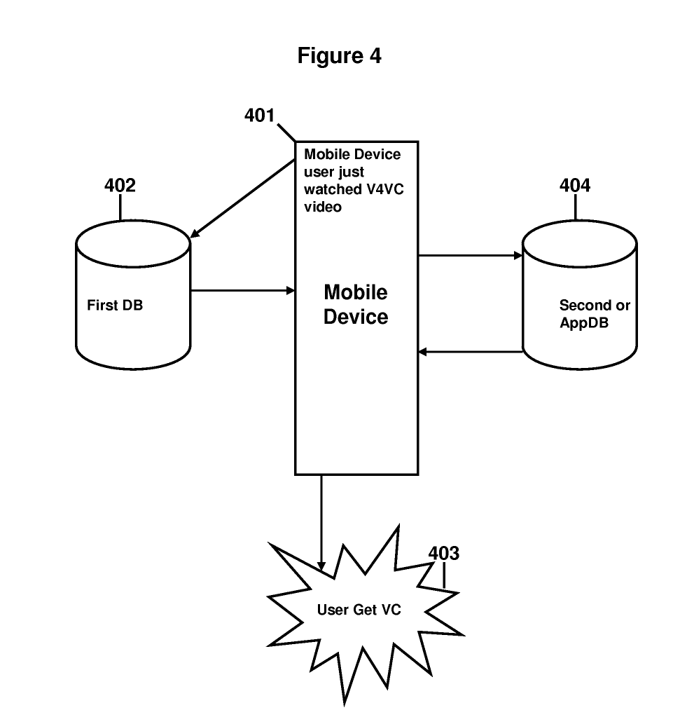

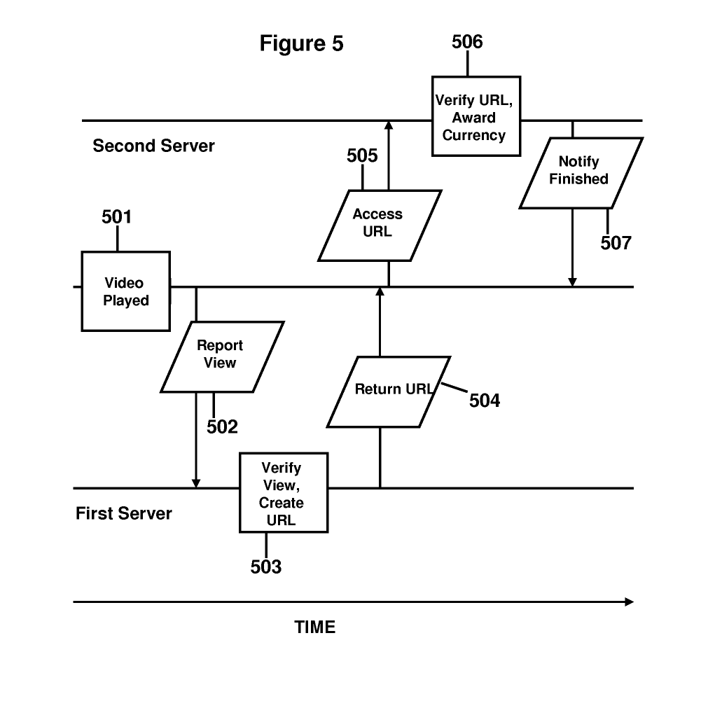

Various embodiments of the present invention for rewarding virtual currency may be further understood by reference to FIG. 4 and to FIG. 5. FIG. 4 is a flow diagram of one embodiment of communication of a mobile device with a remote server (or first DB) and an app server (or second DB) in order to authenticate a reward. Communication to the app server occurs via an API callback, whereupon a reward occurs in a user's virtual currency balance. Upon accruing of the reward, a success message is sent to the user.

Thus, on the mobile device 401, after a user has watched a video for which the user is to be rewarded virtual currency, the device generates and sends a report to a remote server (first DB) 402. The report may be referred to as a video impression identifier. The report may comprise information that indicates one or more if not all of the playing of the video on the device has been completed, what the video was, what the scheduled reward is and the identity of the device. The remote server verifies the video impression, creates a unique URL and encodes the URL with a secret key.

The remote server 402 sends the encoded URL back to the device 401. The device then calls the URL that it received and accesses the app server 404. The app server decodes the URL with the secret key, and checks to see if the video impression identifier has or has not been used. Optionally, the secret key is communicated directly between the first server and the second server. If the video impression identifier has not yet been used, the app server returns a message of success and updates the user balance. If the video impression identifier has been used already, the app server returns a message of decline and does not change the user balance of virtual currency. This latter step can be used to ensure that rewards are not provided to a user who watches the same video multiple times. As persons of ordinary skill in the art will recognize, each video impression identifier may be unique so that users of different devices can each receive virtual currency for watching the same video.

The system may be designed such that upon receipt of a success message, the device contacts a publisher or entity who may record that the video was watched. The system may also display that that the user received the reward 403. The entity that tracks viewing of an advertisement may use the data to design future advertising campaigns. Of particular interest to these entities may be one or more of the number of views of the video by different persons, the time of the viewing, the location of the viewing, etc.

FIG. 5 represents a timeline of the activities described above in connection with FIG. 4. In FIG. 5, a video is played on a mobile device 501. The device sends a report of the completion of the viewing of the device to first server 502. The first server verifies that the video has been viewed and creates a URL 503. The URL is returned to the device 504. The device access the URL on the second server (which may be a developer server) 505. On the second server, there is verification of the URL, and a determination is made as to whether to reward currency 506. After a determination is made, the device is notified of the decision 507, which may be displayed on a graphic user interface of the device to a user.

By way of a non-limiting example, an application developer may configure his or her application to display an ad every time that the application is run. In order to reward the user for watching, the application developer may configure the system on the mobile device itself to award five units of virtual currency for each ad impression. Thus, the method is carried out by activation of an application. The module within the application initializes and requests an ad configuration from an ad server, and if there is internet connectivity available, the ad server assigns one ad to the application. The ad is already stored on the mobile device, and is loaded from the device.

The methods of the current invention may be embodied in one or more protocols that are stored in one or more executable computer program products and tools for creating these technologies may be embodied in a software development kit. The computer program products may for example be stored as part of software, hardware or a combination thereof in a non-transitory storage medium. Furthermore, various embodiments of the present invention may be parts of systems that comprise one or more mobile devices and one or more servers. The mobile devices may be configured to communicate with one or more servers through technologies that are now known or that come to be known to persons of ordinary skill in the art for accessing a server through a network such as the worldwide web.

A “non-transitory tangible computer readable storage medium” may also be referred to as a computer program product, and includes hardware, software or a combination of the two on which one may store a set of instructions that may be used to direct a computer to perform a set of steps. Examples of non-transitory tangible computer readable storage medium include, but are not limited to, a hard drive, a hard disk, a floppy disk, a thumb drive, a computer tape, ROM, EEPROM, nonvolatile RAM, CD-ROM and a punch card. Thus, in some embodiments the instructions are software stored on a medium that can instruct a computer having one or more of the following hardware components: memory, storage, an input device, an output device and a central processing unit.

The term “module” as used in this disclosure refers to a computer program product that may be stored on hardware and/or software that may be activated by a user to carry out a defined set of steps and/or to prompt a user to provide information through, for example, a graphic user interface and/or input/output device. Thus, a module may be stored in the form of a tangible medium. For convenience, various features are described herein as being different modules. However, as persons of ordinary skill in the art will readily recognize, different modules may be part of the same of different computer program products that are configured to interact with each other.

Additionally, the methods, systems and computer program products are preferably configured such that any data that is collected, transmitted and/or saved is appropriately protected against undesirable invasions of privacy. For example, the systems can be designed such that only authorized personnel have access to any data that is collected, and/or the data is automatically deleted after a predetermined amount of time, e.g., two weeks, one month or six months. Alternatively data may be collected and rendered anonymous.

Any of the features of the various embodiments described herein can be used in conjunction with features described in connection with any other embodiments disclosed unless otherwise specified. Thus, features described in connection with the various or specific embodiments are not to be construed as not suitable in connection with other embodiments disclosed herein unless such exclusivity is explicitly stated or implicit from context.

We claim:

1. A method for displaying a video advertisement on a mobile device, said method comprising:
(a) activating an application on a mobile device, wherein said application comprises a video advertisement configuration request module;
(b) transmitting to a remote server, a request for a video advertisement configuration;
(c) receiving from said remote server said video advertisement configuration, wherein said video advertisement configuration comprises at least one parameter for a video advertisement;
(d) retrieving media assets from local storage on the mobile device, wherein said media assets are selected based on information contained within said video advertisement configuration; and
(e) displaying said video advertisement on said mobile device.

2. The method claim 1 further comprising monitoring a history of activity of the mobile device, wherein said monitoring is automated and occurs locally on the mobile device and transmitting with said request, information corresponding to said history.

3. The method according to claim 2, wherein the video advertisement is displayed within a zone of the application designed for an advertisement.

4. The method according to claim 3, wherein the video advertisement comprises a banner.

5. The method according to claim 2, wherein the request further comprises platform operation system information.

6. The method according to claim 1, wherein said application is activated a plurality of times and each time, a request for a video advertisement configuration is created.

7. The method according to claim 6, wherein at least one request is created when the mobile device is not connected to a network, and when said request that is created when the mobile device is not connected to the network, a video advertisement is retrieved from data storage on the mobile device without the device receiving a video advertisement configuration between the time the at least one request is created when the mobile device is not connected to a network and the displaying of the video advertisement.

8. The method according to claim 1, wherein (d) further comprises a filtering step, wherein during said filtering step media assets that are the same as media assets that have previously been downloaded and have not been deleted are not downloaded again.

9. The method according to claim 1, wherein said video advertisement is displayed within a video game.

10. A method for the issuance of virtual currency comprising the method of claim 9 and further comprising creating or updating a virtual currency data file after the completion of display of said advertisement on said mobile device.

11. A mobile device for the delivery of high quality video advertisements comprising a computer program product stored in a non-transitory medium, wherein said computer program product comprises:
(a) a manager module, wherein the manager module is configured to interact with an application and to prepare a request for a data file, wherein said request comprises information corresponding to prior activity of the mobile device and information corresponding to a zone for a video advertisement within the application;
(b) a downloader module, wherein the downloader module is configured to send the request to a remote server, to receive in response to the request an ad file that comprises ad data and media assets and if the ad file corresponds to a new ad, to store the ad file locally on the device, and if the ad file corresponds to an update of an ad already stored on the mobile device, to download only new or modified elements of the ad file, thereby updating an ad file stored on the device; and
(c) a playback module, wherein the playback module causes the mobile device to access the ad file that corresponds to information received in response to the request and stored on the mobile device and to display a video advertisement that corresponds to the ad file that corresponds to information received in response to the request within an application on the mobile device.

12. The mobile device of claim 11, wherein the manager module is configured to create a new request for additional video advertisement configuration data each time an application calls for playing of an advertisement video within an application.

13. The mobile device of claim 12, wherein if the mobile device is connected to the internet when said request is created, the downloader module sends the request to the remote server prior to activation of the playback module and if the mobile device is not connected to the internet, the playback module causes the mobile device to display a video advertisement that is stored locally on the mobile device prior the downloader module sending the request to the remote server, and the downloader module stores the request until the mobile device is connected to the internet, at which time it sends the request.

14. The mobile device of claim 11, wherein the host application is a video game.

15. The mobile device of claim 11, wherein the information corresponding to prior activity comprises a frequency of use of an application.

16. The mobile device of claim 11, wherein the information corresponding to prior activity comprises information corresponding to whether one or more prior video advertisements were displayed on the mobile device in their entirety.

17. A system for delivery of a video advertisement to a mobile device, said system comprising
(a) a server, wherein the server is an ad server, an asset server or an ad/asset server; and
(b) a mobile device, wherein the mobile device is capable of wirelessly communicating with the server, and is the mobile device of claim 11.

18. A method for obtaining virtual currency comprising:
(a) causing a mobile device to display a video within an application that offers virtual currency in exchange for viewing a video;
(b) transmitting from said mobile device to a first server, information that corresponds to an identification of said mobile device and a notification that a video has been viewed;
(c) receiving on said mobile device from said first server, an encoded URL;
(d) accessing a second server from said mobile device through said encoded URL, wherein said second server is configured to decode the encoded URL and to determine whether to reward a user of the mobile device with virtual currency; and
(e) receiving on said mobile device virtual currency.

19. The method of claim 18 further comprising displaying notice of receipt of virtual currency to a user of the mobile device.

20. A mobile device comprising a graphic user interface and a computer program product stored in a non-transitory medium, wherein said computer program product comprises automated instructions to carry out the steps of the method of claim 18.
